(19) United States
(12) Patent Application Publication
(10) Pub. No.: US 2025/0043840 A1
(43) Pub. Date: Feb. 6, 2025

(54) BRAKE PAD MONITORING SYSTEM

(71) Applicant: Norman McGregor, Roy, UT (US)

(72) Inventor: Norman McGregor, Roy, UT (US)

(21) Appl. No.: 18/229,406

(22) Filed: Aug. 2, 2023

(51) Int. Cl. F16D 66/02; B60T 17/22

(52) U.S. Cl. CPC F16D 66/021; B60T 17/22

(57) ABSTRACT

A brake pad monitoring system for detecting when brake pads have worn out includes a brake assembly including a rotor and a brake pad. The brake pad is movable between a disengaged position wherein the brake pad is spaced from the rotor and an engaged position wherein the brake pad is pressed against an engagement surface of the rotor. A laser emitter is mounted to the brake assembly and is configured to emit a laser beam toward the brake pad. A laser sensor is mounted to the brake assembly and is positioned such that the laser sensor is configured to receive the laser beam of the laser emitter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to brake pad monitoring systems and more particularly pertains to a new brake pad monitoring system for detecting when brake pads have worn out.

### (2) Description of Related Art Including Information Disclosed Under 37 CFR 1.97 and 1.98

The prior art describes myriad brake pad monitoring systems which resort to a variety of methods of determining an amount of wear on a brake pad. For example, such systems describe mechanical actuators which are caused to move varying distances when the brake pad engages a rotor based on the thickness of the brake pad, a sensor for detecting a volume of hydraulic fluid in reservoir which varies in response to the thickness of the brake pad, and an electrical circuit which opens when the brake pad reaches a predetermined thickness. However, the prior art does not describe such an apparatus which uses a laser sensor to determine a thickness of the brake pad. Such a system is advantageous over the prior art in that it would obtain thickness measurements that do not vary based on damage or other interference with mechanical actuators or fluid levels. Such a system also would provide more precise measurements than one which is solely directed at determining when a brake pad reaches a threshold thickness.

### BRIEF SUMMARY OF THE INVENTION

An embodiment of the disclosure meets the needs presented above by generally comprising a brake assembly including a rotor and a brake pad. The brake pad is movable between a disengaged position wherein the brake pad is spaced from the rotor and an engaged position wherein the brake pad is pressed against an engagement surface of the rotor. A laser emitter is mounted to the brake assembly and is configured to emit a laser beam toward the brake pad. A laser sensor is mounted to the brake assembly and is positioned such that the laser sensor is configured to receive the laser beam of the laser emitter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a brake pad monitoring system according to an embodiment of the disclosure.

FIG. 2 is a section view of an embodiment of the disclosure taken from Arrows 2-2 in FIG. 1.

FIG. 3 is a front view of a display screen of an embodiment of the disclosure.

### DETAILED DESCRIPTION OF THE INVENTION

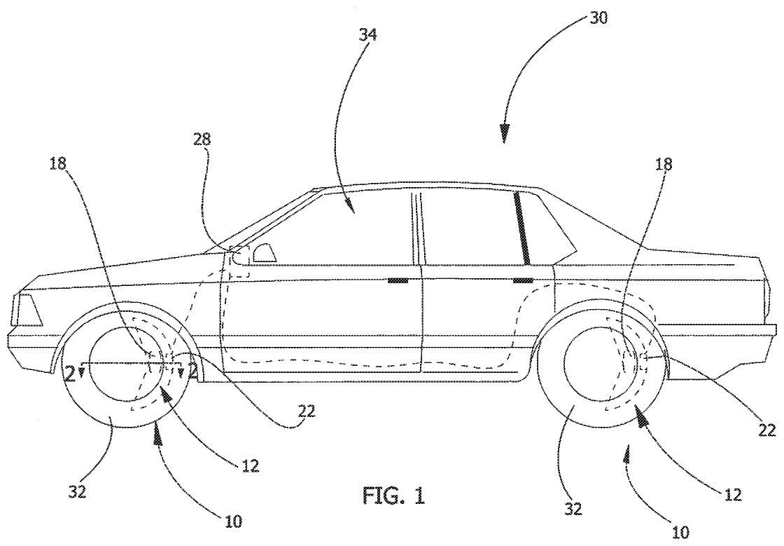

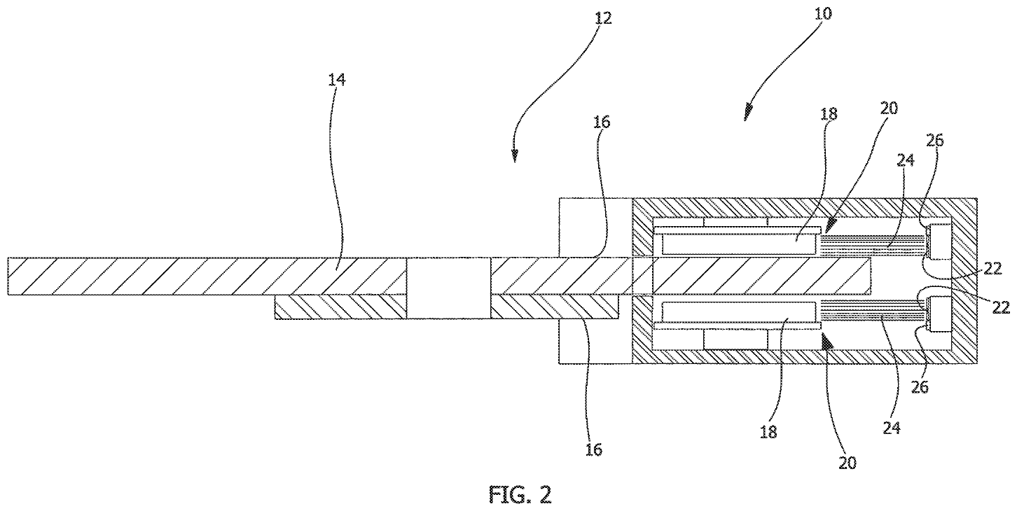

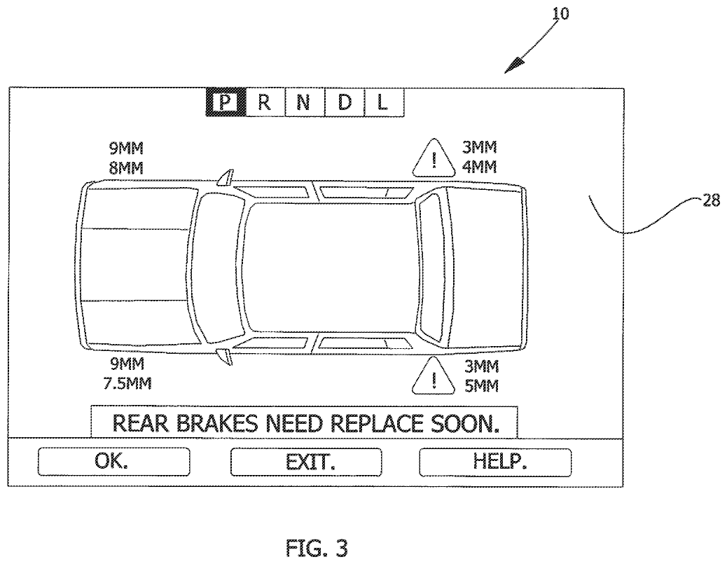

With reference now to the drawings, and in particular to FIGS. 1 through 3 thereof, a new brake pad monitoring system embodying the principles and concepts of an embodiment of the disclosure and generally designated by the reference numeral 10 will be described.

As best illustrated in FIGS. 1 through 3, the brake pad monitoring system 10 generally comprises a brake assembly 12 including a rotor 14 and a pair of brake pads 18. The rotor 14 has a disc shape and has a pair of engagement surfaces 16 which are positioned opposite each other. Each brake pad 18 of the pair of brake pads 18 is movable between a disengaged position 20 wherein the brake pad 18 is spaced from the rotor 14 and an engaged position (not shown) wherein the brake pad 18 is pressed against an associated engagement surface 16 of the pair of engagement surfaces 16 of the rotor 14.

A pair of laser emitters 22 is mounted to the brake assembly 12. Each laser emitter 22 of the plurality of laser emitters 22 is configured to emit a laser beam 24 toward an associated brake pad 18 of the pair of brake pads 18 in a direction parallel to an associated engagement surface 16 of the pair of engagement surfaces 16 of the rotor 14. Each laser emitter 22 of the pair of laser emitters 22 is configured to shape the laser beam 24 to have a constant width taken perpendicularly to the associated engagement surface 16.

A pair of laser sensors 26 is mounted to the brake assembly 12. Each laser sensor 26 of the pair of laser sensors 26 is positioned such that the laser sensor 26 is configured to receive a portion of the laser beam 24 of an associated laser emitter 22 of the pair of laser emitters 22 after the laser beam 24 rebounds off of the associated brake pad 18. Each laser sensor 26 of the pair of laser sensors 26 is configured to determine a thickness of the associated brake pad 18 based on a width of the rebounded laser beam 24 when the associated brake pad 18 is positioned in the disengaged position 20. A display screen 28 is configured to receive and display brake pad 18 thickness data generated by the pair of laser sensors 26 indicative of the thicknesses of the brake pads 18.

In another embodiment, each laser sensor 26 of the pair of laser sensors 26 is positioned opposite the associated laser emitter 22 across the associated brake pad 18. In this embodiment, the laser sensors 26 determine the thickness of the brake pads 18 based on a width of the portion of the laser beams 24 which passes the brake pads 18.

In use, the brake pad monitoring system 10 automatically detects the thickness of the associated brake pad 18, and the display screen 28 indicates the thicknesses of the brake pads 18. Multiple brake pad monitoring systems 10 may be deployed on a vehicle 30, where each brake pad monitoring system 10 is mounted to an associated wheel 32 of the vehicle 30 and a shared display screen 28 is positioned in a cabin 34 of the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A brake pad monitoring system comprising:
a brake assembly comprising:
a rotor; and
a brake pad being movable between a disengaged position wherein the brake pad is spaced from the rotor and an engaged position wherein the brake pad is pressed against an engagement surface of the rotor;
a laser emitter being mounted to the brake assembly, the laser emitter being configured to emit a laser beam toward the brake pad; and
a laser sensor being mounted to the brake assembly, the laser sensor being positioned such that the laser sensor is configured to receive the laser beam of the laser emitter.

2. The system of claim 1, wherein the laser emitter is configured to emit the laser beam in a direction parallel to the engagement surface of the rotor.

3. The system of claim 2, wherein the laser emitter is configured to shape the laser beam to have a constant width taken perpendicularly to the engagement surface, the laser sensor being configured to determine a thickness of the brake pad based on a width of the laser beam when the brake pad is positioned in the disengaged position.

4. The system of claim 1, wherein the laser sensor is positioned such that the laser sensor is configured to receive the laser beam after the laser beam rebounds off of the brake pad.

5. The system of claim 1, further comprising a display screen being configured to receive and display brake pad thickness data generated by the pair of laser sensor indicative of the thickness of the brake pad.

6. A brake pad monitoring system comprising:
a brake assembly comprising:
a rotor, the rotor having a disc shape and having a pair of engagement surfaces, the pair of engagement surfaces being positioned opposite each other; and
a pair of brake pads, each brake pad of the pair of brake pads being movable between a disengaged position wherein the brake pad is spaced from the rotor and an engaged position wherein the brake pad is pressed against the rotor, each brake pad of the pair of brake pads engaging an associated engagement surface of the pair of engagement surfaces when the brake pad is positioned in the engaged position;
a pair of laser emitters being mounted to the brake assembly, each laser emitter of the plurality of laser emitters being configured to emit a laser beam toward an associated brake pad of the pair of brake pads in a direction parallel to an associated engagement surface of the pair of engagement surfaces of the rotor, each laser emitter of the pair of laser emitters being configured to shape the laser beam to have a constant width taken perpendicularly to the associated engagement surface;
a pair of laser sensors being mounted to the brake assembly, each laser sensor of the pair of laser sensors being positioned such that the laser sensor is configured to receive a portion of the laser beam of an associated laser emitter of the pair of laser emitters after the laser beam rebounds off of the associated brake pad, each laser sensor of the pair of laser sensors being configured to determine a thickness of the associated brake pad based on a width of the rebounded laser beam when the associated brake pad is positioned in the disengaged position; and
a display screen being configured to receive and display brake pad thickness data generated by each one of the pair of laser sensors indicative of the thickness of the associated brake pad.
